(19) United States
(12) Patent Application Publication
(10) Pub. No.: US 2008/0102255 A1
(43) Pub. Date: May 1, 2008

(54) Acrylic Decorative Board

(76) Inventor: Yi-Lin Yang, Pu Yan Township (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/876,821

(22) Filed: Oct. 23, 2007

(30) Foreign Application Priority Data
Oct. 26, 2006 (TW) 95218935

(51) Int. Cl. A47G 35/00; B32B 21/04; B32B 9/04

(52) U.S. Cl. 428/195.1; 428/411.1; 428/537.1; 428/542.2

(57) ABSTRACT

A decorative board includes two transparent surface layers spaced from each other, a transparent intermediate layer mounted between the surface layers, and a plurality of decorative members located in the intermediate layer. Thus, the surface layers and the intermediate layer are made of transparent material to expose the decorative members so that the decorative members are exposed from the two surface layers and the intermediate layer to enhance the aesthetic quality of the decorative board. In addition, the decorative members are encompassed by and hidden in the intermediate layer completely and are sandwiched between the two surface layers, so that the decorative members will not protrude outwardly from the two surface layers to facilitate a user clearing the decorative board.

### BACKGROUND OF THE INVENTION

1. Field of the Invention

The present invention relates to a decorative board and, more particularly, to an acrylic decorative board that has an outstanding appearance and can be placed in a house or restaurant to provide an ornamental function.

2. Description of the Related Art

A dried plant, such as a wood, bamboo and the like, can be placed in a house or restaurant to provide an ornamental function. However, it is not easy to clean the surface of the dried plant, thereby causing inconvenience to the user when clearing the dried plant. In addition, the dried plant the surface of the dried plant usually has an irregular shape so that the dried plant cannot be placed in the house or restaurant exactly and easily.

### BRIEF SUMMARY OF THE INVENTION

In accordance with the present invention, there is provided a decorative board, comprising two transparent surface layers spaced from each other, a transparent intermediate layer mounted between the two surface layers, and a plurality of decorative members located in the intermediate layer.

The primary objective of the present invention is to provide a decorative board, wherein the two surface layers and the intermediate layer are made of transparent material to expose the decorative members so that the decorative members are exposed outwardly from the two surface layers and the intermediate layer to enhance the aesthetic quality of the decorative board.

Another objective of the present invention is to provide a decorative board, wherein the decorative members are encompassed by and hidden in the intermediate layer completely and are sandwiched between the two surface layers, so that the decorative members will not protrude outwardly from the two surface layers to facilitate a user clearing the decorative board.

A further objective of the present invention is to provide a decorative board, wherein the manufacturer only needs to fill the intermediate layer into the receiving space between the two surface layers to encompass the decorative members so that the decorative board is made easily and quickly, thereby simplifying the manufacturing process of the decorative board, and thereby decreasing the costs of fabrication of the decorative board.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a decorative board in accordance with the preferred embodiment of the present invention.

FIG. 2 is an exploded perspective view of the decorative board as shown in FIG. 1.

FIG. 3 is a side view of the decorative board as shown in FIG. 1.

FIG. 4 is a perspective view of a decorative board in accordance with another preferred embodiment of the present invention.

### DETAILED DESCRIPTION OF THE INVENTION

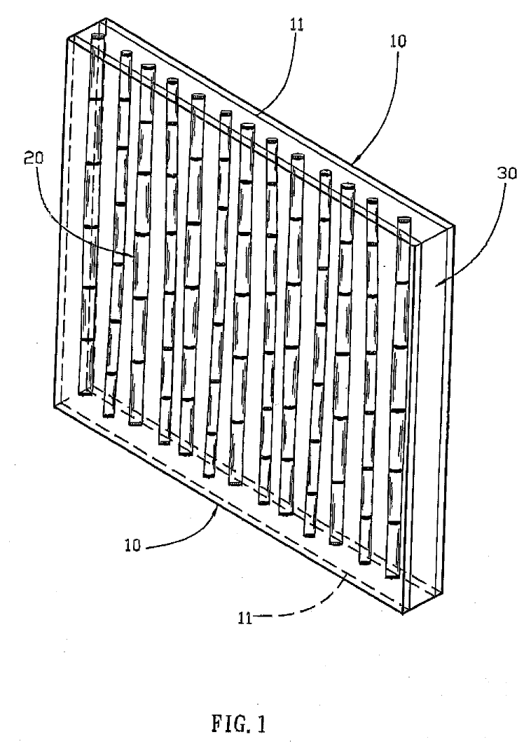

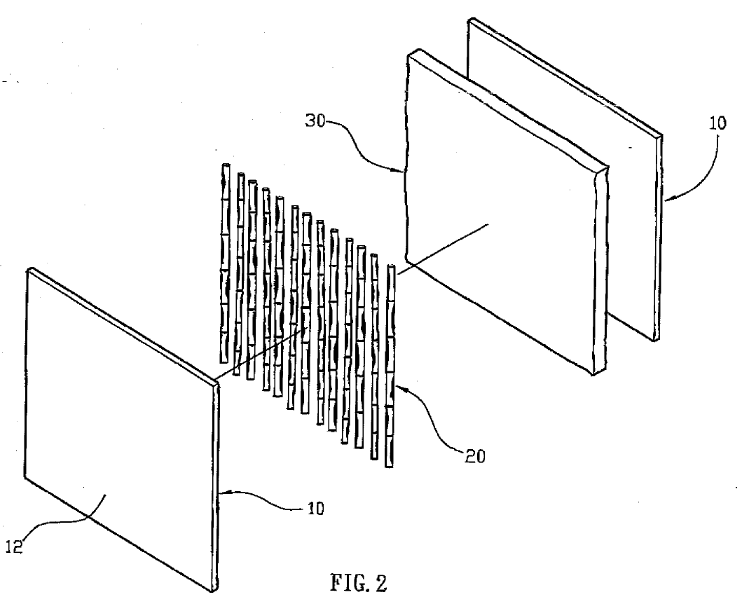

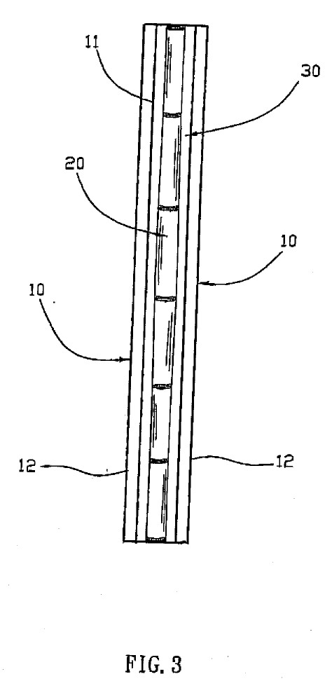

Referring to the drawings and initially to FIGS. 1-3, a decorative board in accordance with the preferred embodiment of the present invention comprises two transparent surface layers 10 spaced from each other, a transparent intermediate layer 30 mounted between the two surface layers 10, and a plurality of decorative members 20 located in the intermediate layer 30.

Each of the two surface layers 10 is made of a solid acrylic plate and has a flat and smooth outer surface 12. Preferably, the outer surface 12 of each of the two surface layers 10 is a plane. Each of the two surface layers 10 has a substantially rectangular profile. A receiving space 11 is defined between the two surface layers 10 to receive the intermediate layer 30 and the decorative members 20.

The decorative members 20 are encompassed by and hidden in the intermediate layer 30 completely and are sandwiched between the two surface layers 10. Each of the decorative members 20 is made of wood, bamboo or other decorative article. Preferably, the decorative members 20 are arranged in a linear shape.

The intermediate layer 30 is made of a solid acrylic plate and has a substantially rectangular profile. The intermediate layer 30 is combined with the two surface layers 10 and the decorative members 20 and has a size flush with that of each of the two surface layers 10. The intermediate layer 30 is in the form of a gum-shaped acrylic fluid before the intermediate layer 30 is combined with the two surface layers 10 and the decorative members 20 and is in the form of a solid acrylic plate after the intermediate layer 30 is combined with the two surface layers 10 and the decorative members 20.

In fabrication, the two surface layers 10 are placed into a die (not shown) to define the receiving space 11 which has an open upper portion and a closed peripheral wall. Then, the decorative members 20 is placed into the receiving space 11 between the two surface layers 10. Then, the intermediate layer 30 in the form of a gum-shaped acrylic fluid is filled into the receiving space 11 between the two surface layers 10 to encompass the decorative members 20. After the intermediate layer 30 is solidified, the intermediate layer 30 is combined with the two surface layers 10 and the decorative members 20 closely to form the decorative board.

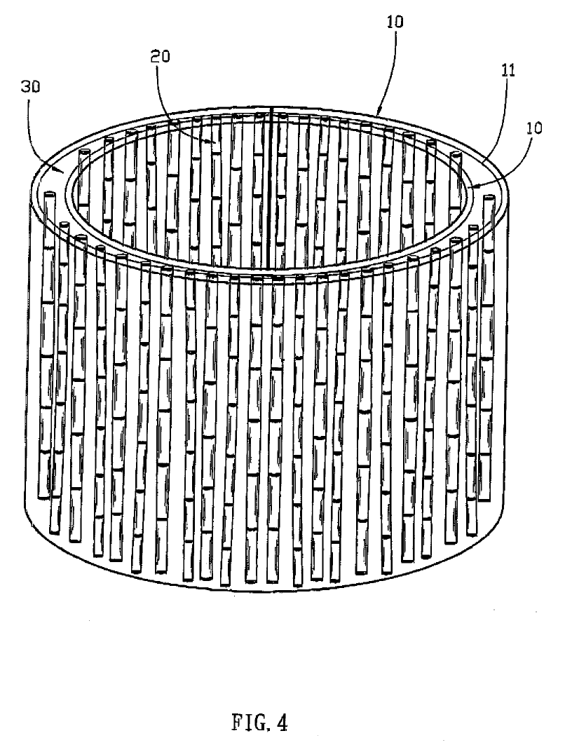

As shown in FIG. 4, each of the two surface layers 10 has a substantially annular profile, the intermediate layer 30 has a substantially annular profile and the decorative members 20 are arranged in an annular shape. In fabrication, the two surface layers 10 are softened by heating so that each of the two surface layers 10 can be bent to have an arbitrary profile.

Accordingly, the two surface layers 10 and the intermediate layer 30 are made of transparent material to expose the decorative members 20 so that the decorative members 20 are exposed outwardly from the two surface layers 10 and the intermediate layer 30 to enhance the aesthetic quality of the decorative board. In addition, the decorative members 20 are encompassed by and hidden in the intermediate layer 30 completely and are sandwiched between the two surface layers 10, so that the decorative members 20 will not protrude outwardly from the two surface layers 10 to facilitate a user clearing the decorative board. Further, the manufacturer only needs to fill the intermediate layer 30 into the receiving space 11 between the two surface layers 10 to encompass the decorative members 20 so that the decorative board is made easily and quickly, thereby simplifying the manufacturing process of to the decorative board, and thereby decreasing the costs of fabrication of the decorative board.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A decorative board, comprising:
two transparent surface layers spaced from each other;
a transparent intermediate layer mounted between the two surface layers;
a plurality of decorative members located in the intermediate layer.

2. The decorative board in accordance with claim 1, wherein a receiving space is defined between the two surface layers to receive the intermediate layer and the decorative members.

3. The decorative board in accordance with claim 1, wherein the decorative members are encompassed by and hidden in the intermediate layer completely.

4. The decorative board in accordance with claim 1, wherein the decorative members are sandwiched between the two surface layers.

5. The decorative board in accordance with claim 1, wherein each of the two surface layers is made of a solid acrylic plate.

6. The decorative board in accordance with claim 1, wherein each of the two surface layers has a flat and smooth outer surface.

7. The decorative board in accordance with claim 6, wherein the outer surface of each of the two surface layers is a plane.

8. The decorative board in accordance with claim 1, wherein the decorative members are arranged in a linear shape.

9. The decorative board in accordance with claim 1, wherein the intermediate layer is made of a solid acrylic plate.

10. The decorative board in accordance with claim 1, wherein the intermediate layer has a substantially rectangular profile.

11. The decorative board in accordance with claim 1, wherein the intermediate layer is combined with the two surface layers and the decorative members.

12. The decorative board in accordance with claim 1, wherein the intermediate layer has a size flush with that of each of the two surface layers.

13. The decorative board in accordance with claim 11, wherein the intermediate layer is in the form of a gum-shaped acrylic fluid before the intermediate layer is combined with the two surface layers and the decorative members.

14. The decorative board in accordance with claim 11, wherein the intermediate layer is in the form of a solid acrylic plate after the intermediate layer is combined with the two surface layers and the decorative members.

15. The decorative board in accordance with claim 1, wherein
each of the two surface layers has a substantially annular profile;
the intermediate layer has a substantially annular profile;
the decorative members are arranged in an annular shape.

16. The decorative board in accordance with claim 1, wherein each of the decorative members is made of wood.

17. The decorative board in accordance with claim 1, wherein each of the decorative members is made of bamboo.
